(19) United States
(12) Patent Application Publication
(10) Pub. No.: US 2009/0258560 A1
(43) Pub. Date: Oct. 15, 2009

(54) Microporous Films

(76) Inventors: Per Magnus Kristiansen, Zurich (CH); Hartmut Römling, Schallstadt (DE); Klaus Stoll, Binzen (DE); Markus Kolb, Kandern (DE)

Correspondence Address: JoAnn Villamizar;Ciba Corporation/Patent Department, 540 White Plains Road, P.O. Box 2005, Tarrytown, NY, 10591, US

(21) Appl. No.: 11/992,705

(22) PCT Filed: Sep. 26, 2006
(86) PCT No.: PCT/EP2006/066753

§ 371 Date: Mar. 27, 2008

(30) Foreign Application Priority Data
Sep. 30, 2005 (EP) 05109068.6

(51) Int. Cl. B32B 27/06; D04H 13/00; C08L 23/06; C08J 9/228; C08L 23/12

(52) U.S. Cl. 442/398; 521/134; 521/79

(57) ABSTRACT

A microporous film made of a composition containing A) 100 to 60 parts by weight of a polypropylene homopolymer, B) 0 to 40 parts by weight of a low density polyethylene or a polyethylene copolymer with butene, hexene or octene, and C) 0.005 to 0.5% by weight, relative to the weight of component A), of at least one beta-nucleating agent selected from the class consisting of organic compounds containing trisamide moieties; the film having a water vapor-permeability of ≧200 g/m2 d at 23° C./50% r.h. or ≧800 g/m2 d at 23° C./85% r.h.

The present invention relates to a microporous film made of a composition comprising polypropylene and optionally polyethylene homo- or copolymer, and a beta-nucleating agent containing trisamide moieties, an article containing said microporous film and a process for producing said microporous film.

Microporous films are for example described in JP-A-1997-255,804, U.S. Pat. No. 5,208,098, U.S. Pat. No. 5,910,225 and EP-A-632,095. Beta-nucleating agents are for example described in WO-A-03/102,069 and U.S. Pat. No. 5,231,126.

The present invention relates in particular to

a microporous film made of a composition containing
A) 100 to 60 parts by weight of a polypropylene homopolymer,
B) 0 to 40 parts by weight of a low density polyethylene or a polyethylene copolymer with butene, hexene or octene, and
C) 0.005 to 0.5% by weight, relative to the weight of component A), of at least one beta-nucleating agent selected from the group consisting of organic compounds containing trisamide moieties;
   the film having a water vapor-permeability of
   ≧200 g/m² d at 23° C./50% r.h. or
   ≧800 g/m² d at 23° C./85% r.h.

Component A) is preferably present in an amount of 95 to 65 parts by weight, in particular 90 to 70 parts by weight.

Component B) is preferably present in an amount of 5 to 35 parts by weight, in particular 10 to 30 parts by weight.

Component C) is preferably present in an amount of 0.01 to 0.1% by weight, in particular 0.015 to 0.05% by weight, relative to the weight of component A).

A preferred embodiment of the present invention relates to a microporous film wherein component A) is present in an amount of 95 to 65 parts by weight, and component B) is present in an amount of 5 to 35 parts by weight.

The water vapor-permeability can be determined according to different test methods depending on the intent of use and the required conditions for breathability.

The water vapor-permeability according to the TAPPI official test method T448 (1997) is preferably 200 to 3000, in particular 300 to 2500 or 500 to 2000 or 750 to 1800, g/m² d at 23° C./50% r.h. (d: day; r.h.: relative humidity).

The water vapor transmission rates can alternatively be measured according to ASTM E398-03 or ISO/CD 15106-1 with a commercial LYSSY Vapor Permeation Tester L80-4000 (MRS Seitter GmbH, Holzmaden, Germany; today part of Dansensor®) operated at 23° C./85% r.h. For the latter, more humid conditions, the water vapor transmission rates are preferably ≧800 g/m² d, for example 800 to 4000 g/m² d, in particular ≧1000 g/m² d, for example 1000 to 3000 g/m² d, and most preferably ≧1500 g/m² d, for example 1500 to 2000 g/m² d.

The thickness of the microporous film is preferably 1 to 250 microns, preferably 5 to 200 microns, more preferably 10 to 150 microns, and most preferably 15 to 100 microns.

It is advantageous to select the polypropylene homopolymer according to the following properties' profile: A melt flow index (MFI, measured according to ASTM D-1238) of 0.5 to 25 dg/min, preferably 0.7 to 15 dg/min, determined at 230° C. under a load of 2.16 kg; a density in the range of 0.87 to 0.93 g/cm³; a melting point (determined as peak temperature by differential scanning calorimetry (DSC) under nitrogen blanket at 10° C./min heating rate) of at least 160° C.

The use of polypropylene homopolymer according to the present invention is independent from its preparation. It can be manufactured by common methods, well described in the literature, as for example by:

Catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

It is advantageous to select the low density polyethylene or a polyethylene copolymer with butene, hexene or octene according to the following properties' profile: A melt flow index (MFI, measured according to ASTM D-1238) of 0.5 to 25 dg/min, preferably 0.7 to 15 dg/min, determined at 190° C. under a load of 2.16 kg; a density in the range of 0.87 to 0.94 g/cm³; a melting point (determined as peak temperature by differential scanning calorimetry (DSC) under nitrogen blanket at 10° C./min heating rate) of less than 130° C.

The use of low density polyethylene or a polyethylene copolymer with butene, hexene or octene according to the present invention is independent from its preparation. It can be manufactured by common methods, well described in the literature. The low density polyethylene or a polyethylene copolymer with butene, hexene or octane can be prepared by catalytic processes as outlined above in gaseous or condensed phase in bulk, solution or slurry at low or at high pressure. Most preferred types of low density polyethylene or polyethylene copolymer are those having a MFI of 0.7 to 15 dg/min and a density of 0.90 to 0.93 g/cm³ and a melting point of less than 125° C.; most preferred comonomers are butene-1 and hexene-1.

According to a preferred embodiment of the present invention the beta-nucleating agent is added in effective amounts enhancing the crystallization peak temperature T_{c} of the polypropylene homopolymer by at least 3° C., preferably by at least 5° C., even more preferably by at least 8° C.

A preferred beta-nucleating agent is a 1,3,5-benzenetricarboxylic acid trisamide derivative, in particular a compound of the formula (I),

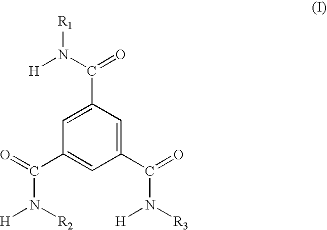

in which R₁, R₂ and R₃, independently of one another, are
C₁-C₂₀alkyl,
C₂-C₂₀alkyl substituted by C₁-C₁₀alkylamino, di(C₁-C₁₀alkyl)amino, C₁-C₁₀alkyloxy or hydroxy;
C₃-C₂₀alkenyl,
C₅-C₁₂cycloalkyl,
C₅-C₁₂cycloalkyl substituted by 1, 2 or 3 C₁-C₁₀alkyl;
cyclohexylmethyl;
cyclohexylmethyl substituted by 1, 2 or 3 C₁-C₁₀alkyl;
C₅-C₉cycloalkenyl,
C₅-C₉cycloalkenyl substituted by 1, 2 or 3 C₁-C₁₀alkyl;
phenyl substituted by 1, 2 or 3 radicals selected from the group consisting of C₁-C₁₀alkyl,
C₁-C₁₀alkyloxy, hydroxy, halogen, trihalogenmethyl, trihalogenmethoxy, benzoyl, phenylamino, acylamino and phenylazo;
C₇-C₉phenylalkyl,
C₇-C₉phenylalkyl which is substituted on the phenyl by 1, 2 or 3 radicals selected from the group consisting of C₁-C₁₀alkyl, C₁-C₁₀alkoxy and hydroxy;
naphthyl,
naphthyl substituted by C₁-C₁₀alkyl,
adamantyl, or
a 5 to 6 membered heterocyclic group.

The compounds of the formula (I) are known and can be prepared for example in analogy to the method described in WO-A-03/102,069.

Examples of C₁-C₂₀alkyl are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methyl-hexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methyl-undecyl, dodecyl, 1,1,3,3,5,5-hexamethylhexyl, tridecyl, tetradecyl, pentadecyl, hexadecyl, heptadecyl, octadecyl and eicosyl. Preferred is branched C₃-C₂₀alkyl, in particular t-butyl and t-octyl.

Examples of C₂-C₂₀alkyl substituted by C₁-C₁₀alkylamino, di(C₁-C₁₀alkyl)amino, C₁-C₁₀alkyloxy or hydroxy are 3-methylaminopropyl, 2-dimethylaminoethyl, 2-diethylaminoethyl, 3-dimethylaminopropyl, 3-diethylaminopropyl, 2-methoxyethyl, 2-ethoxyethyl, 2-methoxypropyl, 3-methoxypropyl, 2-ethoxypropyl, 3-isopropoxypropyl and hydroxyethyl.

Preferred examples are 3-dimethylaminopropyl, 3-methoxypropyl and 2-methoxyethyl.

Examples of C₃-C₂₀alkenyl are allyl, 2-methallyl, butenyl, pentenyl, hexenyl and oleyl. The carbon atom in position 1 is preferably saturated. Particularly preferred examples are allyl and oleyl.

Examples of C₅-C₁₂cycloalkyl are cyclopentyl, cyclohexyl, cycloheptyl, cyclooctyl and cyclododecyl.

Preferred examples are cyclohexyl, cycloheptyl, cyclooctyl and cyclododecyl.

Preferred examples of C₅-C₁₂cycloalkyl substituted by 1, 2 or 3 C₁-C₁₀alkyl are 3-methylcyclohexyl and 2,3-dimethylcyclohexyl.

An example of cyclohexylmethyl substituted by 1, 2 or 3 C₁-C₁₀alkyl is 1-cyclohexylethyl.

An example of C₅-C₉cycloalkenyl is cyclohexenyl.

An example of C₅-C₉cycloalkenyl substituted by 1, 2 or 3 C₁-C₁₀alkyl is methylcyclohexenyl.

Examples of phenyl substituted by 1, 2 or 3 radicals selected from the group consisting of C₁-C₁₀alkyl, C₁-C₁₀alkyloxy, hydroxy, halogen, trihalogenmethyl, trihalogenmethoxy, benzoyl, phenylamino, acylamino and phenylazo are 4-methylphenyl, 2-ethylphenyl, 4-ethylphenyl, 4-isopropylphenyl, 4-tert-butylphenyl, 4-sec-butylphenyl, 4-isobutylphenyl, 3,5-dimethylphenyl, 3,4-dimethylphenyl, 2,4-dimethylphenyl, 2,6-diethylphenyl, 2-ethyl-6-methylphenyl, 2,6-diisopropylphenyl, 4-methoxyphenyl, 4-ethoxyphenyl, 4-hydroxyphenyl, 4-fluorophenyl, 3,5-difluorophenyl, 2-chlorophenyl, 3-chlorophenyl, 3-chloro-6-methylphenyl, 3,5-di(trifluoromethyl)phenyl, 4-trifluoromethoxyphenyl, 2-benzoylphenyl, 4-phenylaminophenyl, 4-acetamidophenyl and 4-(phenylazo)phenyl.

A preferred example is 3,4-dimethylphenyl.

Examples of C₇-C₉phenylalkyl are benzyl and 2-phenylethyl. Benzyl is preferred.

Examples of C₇-C₉phenylalkyl which is substituted on the phenyl by 1, 2 or 3 radicals selected from the group consisting of C₁-C₁₀alkyl, C₁-C₁₀alkoxy and hydroxy are methylbenzyl, dimethylbenzyl, trimethylbenzyl, tert-butylbenzyl, methoxybenzyl and 3,5-di-tert-butyl-4-hydroxybenzyl.

An example of naphthyl substituted by C₁-C₁₀alkyl is methylnaphthyl.

Examples of a 5 to 6 membered heterocyclic group are 2-picolyl, (2-furyl)methyl, (2-tetrahydrofuryl)methyl, 2-pyrimidyl, 6-methyl-2-pyridyl, 1,2,4-triazol-3-yl and 2-(1-piperazinyl)ethyl.

R₁, R₂ and R₃, independently of one another, are preferably branched C₃-C₂₀alkyl, or C₅-C₈cycloalkyl unsubstituted or substituted by 1, 2 or 3 C₁-C₄alkyl.

R₁, R₂ and R₃ are in particular identical and are tert-octyl, 2,3-dimethylcyclohexyl or cyclooctyl.

The beta-nucleating agent applied according to the present invention may be incorporated into the thermoplastic polymer or polymer blend by commonly used industrial techniques prior to or during melt processing. The beta-nucleating agent can be applied in pure form or in mixtures with other commonly used additives. It can also be added in the form of a solid powder blend with polymer fluff, as a concentrate or masterbatch (which contain this compound in a concentration of, for example, 1 to 50%, in particular 1 to 10%) or as a liquid preparation in form of a melt, solution or dispersion in suitable carrier materials. The beta-nucleating agent can be added to a blend of polypropylene and polyethylene according to the present invention, more preferably, it is added to the polypropylene component prior to subsequent processing steps.

The compositions used according to the present invention may optionally contain one or more conventional additives. Suitable examples are

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethyl-phenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E).
1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.
1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.
1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)iso-cyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)iso-cyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol-propane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylol-propane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid e.g. N,N′-bis(3,5-di-tert-butyl-4-hydroxyphenyl propionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenyl-amines, a mixture of mono- and dialkylated nonyldiphenylamines, a mixture of mono- and dialkylated dodecyldiphenylamines, a mixture of mono- and dialkylatedisopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. 2-(2′-Hydroxyphenyl)benzotriazoles, for example 2-(2′-hydroxy-5′-methylphenyl)-benzo-triazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethyl butyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethyl benzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyl-oxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetramethylbutyl)-phenyl]-benzotriazole; 2-[2′-hydroxy-3′-(1,1,3,3-tetramethylbutyl)-5′-(α,α-dimethyl benzyl)-phenyl]benzotriazole.
2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-di-phenylacrylate.
2.5. Nickel compounds, for example nickel complexes of 2,2′-thio-bis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.
2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.
2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydro-oxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl)phosphite, trilauryl phosphite, trioctadecyl phosphite, distearylpentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl)phosphite (Irgafos® 168, Ciba Specialty Chemicals Inc.), tris(nonylphenyl)phosphite,

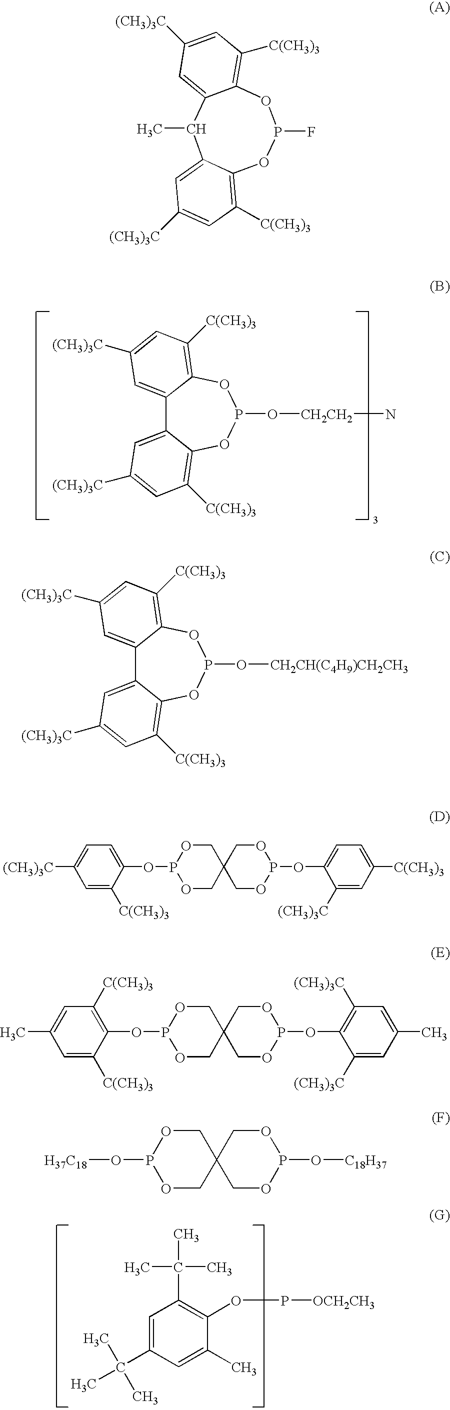

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-hepta-decylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, distearyl thiodipropionate or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.
9. Polyamide stabilizers, for example copper salts in combination with iodides and/or phosphorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, iron oxides in particular nano-sized Fe₃O₄, phosphates, carbonates or sulfates of, preferably, alkaline earth metals; organic compounds, such as mono- or polycarboxylic acids and the salts thereof, as for example 4-tert-butylbenzoic acid, adipic acid, diphenylacetic acid, sodium succinate or sodium benzoate; polymeric compounds, such as polyvinylcyclohexane or ionic copolymers (ionomers); phthalocyanine or quinacridone pigments; any derivatives of aliphatic or aromatic dicarboxylic acids having nucleating activity, such as derivatives of hexahydrophthalic acid, bicyclo[2.2.1]heptane dicarboxylic acid, bicyclo[2.2.2]octane dicarboxylic acid, adipic acid, pimelic acid, subaric acid, sebacic acid, phthalic acid, isophthalic acid, terephthalic acid, naphthaline dicarboxylic acid, in particular the salts of those acids with alkaline or alkaline earth metals, per se or generated in situ by combining those acids with alkaline or alkaline earth stearates or the like, as well as the corresponding amides of said acids, which may be further N-substituted with organic groups, eventually resulting in derivatives with nucleating activity. Especially preferred are the bis-acetals of sorbitol or mannitol like for example 1,3:2,4-bis(3′,4′-dimethylbenzylidene)sorbitol, 1,3:2,4-di(para-methyldibenzylidene)sorbitol, 1,3:2,4-di(para-ethyldibenzylidene)sorbitol, 1,3:2,4-di(mono-fluoro-dibenzylidene)sorbitol, 1,3:2,4-di(mono-chloro-dibenzylidene)sorbitol, 1,3:2,4-di(mono-methyl-mono-chloro-dibenzylidene)sorbitol and 1,3:2,4-di(benzylidene)sorbitol.
12. Fillers and reinforcing agents, for example calcium carbonate, silicates, glass fibres, glass beads, asbestos, talc, kaolin, mica, barium sulfate, metal oxides and hydroxides, car-bon black, graphite, wood flour and flours or fibers of other natural products, synthetic fibers.
13. Other additives, for example plasticisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl-benzofuran-2-one.

The conventional additive is preferably present in the composition used according to the present invention in an amount of 0.001 to 10, preferably 0.01 to 5, parts by weight.

Another embodiment of the present invention is an article comprising a microporous film made of a composition containing
A) 100 to 60 parts by weight of a polypropylene homopolymer,
B) 0 to 40 parts by weight of a low density polyethylene or a polyethylene copolymer with butene, hexene or octene, and
C) 0.005 to 0.5% by weight, relative to the weight of component A), of at least one beta-nucleating agent selected from the class consisting of organic compounds containing trisamide moieties;
   the film having a water vapor-permeability of
   ≧200 g/m² d at 23° C./50% r.h. or
   ≧800 g/m² d at 23° C./85% r.h.

The article is preferably a construction material, a functional material, a packaging material, a moisture-permeable waterproof garment or a hygienic article.

Examples of construction materials are geotextile films or foils, heat and sound insulation materials, drainage and isolation membranes, separating fleeces and roofing membranes. A roofing membrane is preferred.

Examples of packaging materials include breathable packaging films or foils for food, detergents and pharmaceuticals, artificial paper, films or foils for printable substrates, shrink-films, in-mold labels and the like.

Moisture-permeable waterproof garments are for example light rainwear and light work clothes, camping equipment such as tents and sleeping bags, disposable protective garment used in hospitals (e.g. surgical dressings, bandages, infection barrier clothing), electronic clean rooms and areas where chemical spills may be a problem. Further applications in the clothing area include sportswear, linings and decorative coverings.

Examples of hygienic articles are paper diapers (disposable diapers, pants-shaped diapers, etc.), sanitary napkins and other sanitary products like towels or table linen, incontinence pads and absorbent articles, bed sheets and other hygienic merchandise such as face oil removers.

A preferred article of the present invention is a roofing membrane wherein the beta-nucleating agent is 1,3,5-benzenetricarboxylic acid tris(tert-octylamide) or 1,3,5-benzenetricarboxylic acid tris(2,3-dimethylcyclohexylamide).

Other preferred embodiments of the present invention relate to:

I) An article as defined above, which is a composite additionally comprising a nonwoven web laminated on the microporous film.
II) An article as defined above, which is a composite wherein the microporous film is sandwiched between two nonwoven webs.
III) An article as defined above, which is a roofing membrane, wherein the microporous film is sandwiched between two nonwoven webs and the beta-nucleating agent is 1,3,5-benzenetricarboxylic acid tris(tert-octylamide) or 1,3,5-benzenetricarboxylic acid tris(2,3-dimethylcyclohexylamide).

A further embodiment of the present invention is a process for producing a microporous film, which comprises
a) blending and extrusion of a composition containing
A) 100 to 60 parts by weight of a polypropylene homopolymer,
B) 0 to 40 parts by weight of a low density polyethylene or a polyethylene copolymer with butene, hexene or octene, and
C) 0.005 to 0.5% by weight, relative to the weight of component A), of at least one beta-nucleating agent selected from the class consisting of organic compounds containing trisamide moieties;
at an extrusion temperature of 180° to 280° C., preferably 200° to 250° C., into a mono- or multi-layer film;
b) controlled crystallization of said film on one or more chill rolls at a temperature of 80° to 140° C., preferably 100° to 130° C. or 110° to 125° C.;
c) stretching the film in at least one direction at a temperature of 25° to 140° C. and at a draw ratio of 1:1.2 to 1:10.

The stretching of the film in at least one direction is preferably carried out at a temperature of 50° C. to 120° C., in particular 70° C. to 100° C., at a draw ratio of preferably 1:1.5 to 1:8, in particular 1:1.5 to 1:5. The preferred stretching direction is the machine direction, i.e. the direction in which extrusion and feeding of said film is carried-out.

If desired, the microporous film according to the present invention can be prepared by biaxially stretching, which may be conducted either sequentially or simultaneously. For such processes the stretching temperatures may be the same or different from the ones described above. Any further adjustments required, however, can be easily made during processing and are evident to those skilled in the art. Particularly in sequential biaxial stretching usually different stretching temperatures are applied for the orientation in machine and transverse direction, and may approach even up to 190° C. Accordingly, necessary adjustments of the drawing temperatures for biaxial drawing are incorporated by entirety herewithin.

Before stretching, the films have preferably a beta-polypropylene content of 30 to 80% as determined from differential scanning calorimetry (DSC). The beta-polypropylene content is measured by DSC (at 10° C./min heating under nitrogen blanket) from the area ratios of the respective melting peaks as:

% of beta-PP=100%×peak area(beta-PP)/[peak area(alpha-PP)+peak area(beta-PP)]

The DSC melting peaks of alpha-PP and beta-PP, respectively, can be easily attributed due to their different melt temperature ranges of typically T_{m(alpha-PP)}=160 to 170° C. and T_{m(beta-PP)}=145 to 155° C., respectively. The individual peak areas of those melting peaks are determined by common procedures, DSC standard software and operations' manuals or recommendations of DSC equipment manufacturers.

Still another preferred object of the present invention is a microporous film having a thickness of 1 to 250 microns and made of a composition containing
A) 95 to 65 parts by weight of a polypropylene homopolymer,
B) 5 to 35 parts by weight of a low density polyethylene or a polyethylene copolymer with butene, hexene or octene, and
C) 0.005 to 0.5% by weight, relative to the weight of component A), of at least one beta-nucleating agent selected from the class consisting of organic compounds containing trisamide moieties.

The preferred embodiments indicated above also relate to this film.

The following examples describe the present invention in more detail. All parts and percentages are given by weight unless indicated otherwise.

### Beta-Nucleating Agents Used in the Following Examples:

### Beta-Nucleating Agent (1-1):

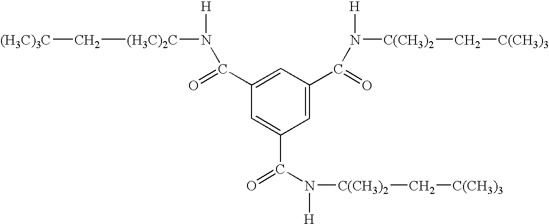

### Beta-Nucleating Agent (1-2):

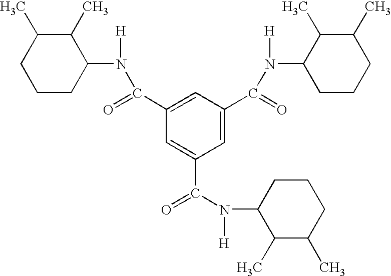

### EXAMPLE 1

A blend of 85 parts by weight of polypropylene homopolymer (Moplen® HP-522H, MFI=2 dg/min at 230° C./2.16 kg, Tₘ=165° C.) further containing the beta-nucleating agent (1-1) at a concentration of 0.024% by weight, relative to the weight of the polypropylene homopolymer, and 15 parts by weight of low density polyethylene (Exxonmobil® LL 4004 EL, an ethylene copolymer with butene-1 having a MFI=3.6 dg/min at 190° C./2.16 kg, a density of 0.924 g/cm³ and a Tₘ=123° C.) is twin-screw compounded at 220-240° C. Subsequently, film samples are prepared by compression molding at 250° C. followed by controlled crystallization at 120° C. before final cooling down to room temperature. Characterized by DSC, these films show a beta-polypropylene content of 45%. Subsequent stretching of these films at different temperatures and a draw ratio of 1:3 yield whitish porous films with soft touch and water vapor transmission rates as listed in Table 1 within the desired range.

TABLE 1

| Drawing temperature | Final film thickness | Water vapor transmission |
|---|---|---|
| [° C.] | [microns] | [g/m² d at 23° C./50% r.h.] |
| 70 | 73 | 1342 |
| 80 | 60 | 1627 |
| 90 | 72 | 1682 |
| 100 | 65 | 697 |

### EXAMPLE 2

Blends of 80-100 parts by weight of polypropylene homopolymer (Moplen® HP-522H, MFI=2 dg/min at 230° C./2.16 kg, Tₘ=165° C.) further containing the beta-nucleating agent (I-1) at a concentration of 0.020% by weight, relative to the weight of the entire formulation, and 20-0 parts by weight of low density polyethylene (LLDPE; Exxonmobil® LL 4004 EL, an ethylene copolymer with butene-1 having a MFI=3.6 dg/min at 190° C./2.16 kg, a density of 0.924 g/cm³ and a Tₘ=123° C.) is twin-screw compounded at 220-240° C. Subsequently, 50 micron film samples are prepared by extrusion at 210° C. followed by controlled crystallization at 120° C. on a heated chill roll. Characterized by DSC, these films show beta-polypropylene contents in the range 20-40%. Subsequent simultaneous biaxial stretching of these films at 70° C. (KARO IV, laboratory stretching unit) to a draw ratio of 2.5×2.5 yield whitish porous films with soft touch and water vapor transmission rates (LYSSY standard 23° C./85% r.h.) as listed in Table 2 within the desired range, emphasizing the benefit of LLDPE co-addition.

TABLE 2

| LLDPE content | Final film thickness | Water vapor transmission |
|---|---|---|
| [%] | [microns] | [g/m² d at 23° C./85% r.h.] |
| 0 | 30 | 942 |
| 5 | 35 | 1102 |
| 10 | 28 | 1169 |
| 15 | 20 | 1270 |
| 20 | 27 | 1030 |

### EXAMPLE 3

Still unstretched films prepared in analogy to EXAMPLE 2 are subjected to a two-step tensile drawing at 70° C. First the films are stretched to a draw ratio of 2 in the machine direction, followed by stretching in the transverse direction (draw ratio:1.5) in order to compensate for the lateral contraction encountered during the first deformation step. This procedure reproducibly yield samples virtually drawn in only one direction. Table 3 summarizes the film characteristics, again emphasizing the positive influence of LLDPE co-addition.

TABLE 3

| LLDPE content | Final film thickness | Water vapor transmission |
|---|---|---|
| [%] | [microns] | [g/m² d at 23° C./85% r.h.] |
| 0 | 57 | 863 |
| 5 | 76 | 1182 |
| 10 | 71 | 1422 |
| 15 | 64 | 1536 |
| 20 | 60 | 1320 |

### EXAMPLE 4

Blends of 90 parts by weight of polypropylene (Moplen® HP552R, MFI=25 dg/min at 230° C./2.16 kg, Tₘ=165° C.) further containing either the beta-nucleating agent (1-1) or (1-2) at a concentration of 0.01-0.02% by weight, relative to the weight of the entire formulation, and 10 parts by weight of low density polyethylene (Exxonmobil® LL 4004 EL, an ethylene copolymer with butene-1 having a MFI=3.6 dg/min at 190° C./2.16 kg, a density of 0.924 g/cm³ and a Tₘ=123° C.) are twin-screw compounded at 220-240° C. These formulations are then extruded at 230° C. onto a chill roll set at 124° C., yielding 100 micron thick films. These films are subsequently stretched as described in EXAMPLE 3. The obtained results for the water vapor transmission rates are summarized in Table 4.

TABLE 4

| Beta | Beta nucleating | Final film | Water vapor |
|---|---|---|---|
| nucleating | agent loading | thickness | transmission |
| agent | [%] | [microns] | [g/m² d at 23° C./85% r.h.] |
| (I-1) | 0.02 | 69 | 1835 |
| (I-2) | 0.01 | 62 | 1814 |
| (I-2) | 0.02 | 78 | 1547 |

1. A microporous film made of a composition containing
A) 100 to 60 parts by weight of a polypropylene homopolymer,
B) 0 to 40 parts by weight of a low density polyethylene or a polyethylene copolymer with butene, hexene or octene, and
C) 0.005 to 0.5% by weight, relative to the weight of component A), of at least one beta-nucleating agent selected from the class consisting of organic compounds containing trisamide moieties;
the film having a water vapor-permeability of
≧200 g/m² d at 23° C. 50% r.h. or
≧800 g/m² d at 23° C. 85% r.h.

2. A microporous film according to claim 1, wherein the water vapor-permeability is ≧200 g/m² d at 23° C./50% r.h.

3. A microporous film according to claim 1, wherein component A) is present in an amount of 95 to 65 parts by weight, and component B) is present in an amount of 5 to 35 parts by weight.

4. A microporous film according to claim 1, wherein the beta-nucleating agent enhances the crystallization peak temperature T_{c} of the polypropylene homopolymer by at least 3° C.

5. A microporous film according to claim 1, wherein the beta-nucleating agent is a 1,3,5-benzenetricarboxylic acid trisamide derivative.

6. A microporous film according to claim 1, wherein the beta-nucleating agent is a compound of the formula (I), 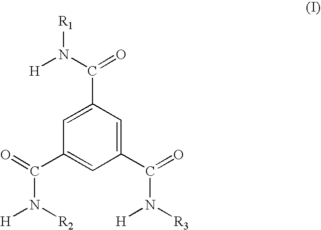
in which R₁, R₂ and R₃, independently of one another, are
C₁-C₂₀alkyl,
C₂-C₂₀alkyl substituted by C₁-C₁₀alkylamino, di(C₁-C₁₀alkyl)amino, C₁-C₁₀alkyloxy or hydroxy;
C₃-C₂₀alkenyl,
C₅-C₁₂cycloalkyl,
C₅-C₁₂cycloalkyl substituted by 1, 2 or 3 C₁-C₁₀alkyl;
cyclohexylmethyl;
cyclohexylmethyl substituted by 1, 2 or 3 C₁-C₁₀alkyl;
C₅-C₉cycloalkenyl,
C₅-C₉cycloalkenyl substituted by 1, 2 or 3 C₁-C₁₀alkyl;
phenyl substituted by 1, 2 or 3 radicals selected from the group consisting of C₁-C₁₀alkyl, C₁-C₁₀alkyloxy, hydroxy, halogen, trihalogenmethyl, trihalogenmethoxy, benzoyl, phenylamino, acylamino and phenylazo;
C₇-C₉phenylalkyl,
C₇-C₉phenylalkyl which is substituted on the phenyl by 1, 2 or 3 radicals selected from the group consisting of C₁-C₁₀alkyl, C₁-C₁₀alkoxy and hydroxy;
naphthyl,
naphthyl substituted by C₁-C₁₀alkyl,
adamantyl, or
a 5 to 6 membered heterocyclic group;

7. A microporous film according to claim 6, wherein
R₁, R₂ and R₃, independently of one another, are
branched C₃-C₂₀alkyl, or
C₅-C₈cycloalkyl unsubstituted or substituted by 1, 2 or 3 C₁-C₄alkyl.

8. A microporous film according to claim 6, wherein
R₁, R₂ and R₃ are identical and are tert-octyl, 2,3-dimethylcyclohexyl or cyclooctyl.

9. An article comprising a microporous film made of a composition containing
A) 100 to 60 parts by weight of a polypropylene homopolymer,
B) 0 to 40 parts by weight of a low density polyethylene or a polyethylene copolymer with butene, hexene or octene, and
C) 0.005 to 0.5% by weight, relative to the weight of component A), of at least one beta-nucleating agent selected from the class consisting of organic compounds containing trisamide moieties;
the film having a water vapor-permeability of
≧200 g/m² d at 23° C. 50% r.h. or
≧800 g/m² d at 23° C. 85% r.h.

10. An article according to claim 9, which is a construction material, a packaging material, a moisture-permeable waterproof garment or a hygienic article.

11. An article according to claim 9, which is a roofing membrane.

12. An article according to claim 9, which is a roofing membrane wherein the beta-nucleating agent is 1,3,5-benzenetricarboxylic acid tris(tert-octylamide) or 1,3,5-benzenetricarboxylic acid tris(2,3-dimethylcyclohexylamide).

13. An article according to claim 9, which is a composite additionally comprising a nonwoven web laminated on the microporous film.

14. An article according to claim 9, which is a composite wherein the microporous film is sandwiched between two nonwoven webs.

15. An article according to claim 9, which is a roofing membrane, wherein the microporous film is sandwiched between two nonwoven webs and the beta-nucleating agent is 1,3,5-benzenetricarboxylic acid tris(tert-octylamide) or 1,3,5-benzenetricarboxylic acid tris(2,3-dimethylcyclohexylamide).

16. A process for producing a microporous film, which comprises
a) blending and extrusion of a composition containing
A) 100 to 60 parts by weight of a polypropylene homopolymer,
B) 0 to 40 parts by weight of a low density polyethylene or a polyethylene copolymer with butene, hexene or octene, and
C) 0.005 to 0.5% by weight, relative to the weight of component A), of at least one beta-nucleating agent selected from the class consisting of organic compounds containing trisamide moieties;
at an extrusion temperature of 180° to 280° C. into a mono- or multi-layer film;
b) controlled crystallization of said film on one or more chill rolls at a temperature of 80° to 140° C.;
c) stretching the film in at least one direction at a temperature of 25° to 140° C. and at a draw ratio of 1:1.2 to 1:10.
